(19) United States
(12) Patent Application Publication
(10) Pub. No.: US 2022/0385465 A1
(43) Pub. Date: Dec. 1, 2022

(54) RECOVERING PUBLIC KEYS

(71) Applicant: Hewlett-Packard Development Company, L.P., Spring, TX (US)

(72) Inventors: Thalia May Laing, Bristol (GB); Joshua Serratelli Schiffman, Bristol (GB); Remy Husson, Bristol (GB)

(21) Appl. No.: 17/755,910

(22) PCT Filed: Dec. 12, 2019
(86) PCT No.: PCT/US2019/065964

§ 371 Date: May 11, 2022

(51) Int. Cl. H04L 9/08; H04L 9/30; H04L 9/32; H04L 9/14

(52) U.S. Cl. CPC H04L 9/0894; H04L 9/30; H04L 9/3268; H04L 9/14; H04L 9/0825; H04L 9/3247

(57) ABSTRACT

In an example, a method includes receiving a signed message generated by a computing device associated with a private key and a public key. The signed message includes an input message signed with the private key. The method further includes generating, using processing circuitry, a candidate public key based on the input message and the signed message using a public key recovery procedure. The method further includes determining the public key associated with the computing device based on an indication as to whether or not the candidate public key corresponds to the public key associated with the computing device.

### BACKGROUND

Public key cryptography may enable authentication of a private key holder using a public key. An identity may be provisioned to a key-holding computing device using a certificate to bind an identity attribute associated with the computing device to a public key associated with the computing device.

### BRIEF DESCRIPTION OF DRAWINGS

Non-limiting examples will now be described with reference to the accompanying drawings, in which:

FIG. 1 is a flowchart of an example method of recovering a public key;

FIG. 2 is a simplified schematic illustration of systems for recovering a public key;

FIG. 3 is a flowchart of an example method of recovering a public key;

FIG. 4 is a simplified schematic illustration of an example apparatus for implementing certain methods; and

FIG. 5 is a simplified schematic illustration of an example machine-readable medium associated with a processor.

### DETAILED DESCRIPTION

A certificate authority (CA) may issue a certificate for a computing device's public key. For example, a CA may issue a certificate for a webserver's public key associated with the owner of a web domain. Such certificates may be provided on demand by the key holder to a verifier, to enable an authentication protocol to prove the key holder's identity.

This provision of certificates may be implemented by certain web-scale computing devices where there are no or few constraints in terms of transmitting certificates in a communication network. However, other computing devices such as Internet of Things (IoT) devices and embedded systems may be constrained in terms of their capability to store and transmit certificates in a communication network. For example, such computing devices may have a small amount of persistent memory (e.g., due to costs), which is unlikely to be dedicated to certificate storage due to the certificate size in memory terms. In some cases, certificates may be stored in a volatile memory, which may be unsuitable for long-term storage of certificates (e.g., due to the potential for the volatile memory to fail or become inaccessible). The process for recovering a certificate to a computing device may be considered to be complicated to secure. Further, certain computing devices may utilize a low bandwidth communication medium such as Bluetooth, Quick Response (QR) codes or low power radio to communicate data. Communicating data such as a 3 KB Rivest-Shamir-Adleman (RSA)-based certificate may be slow over such a low bandwidth communication medium.

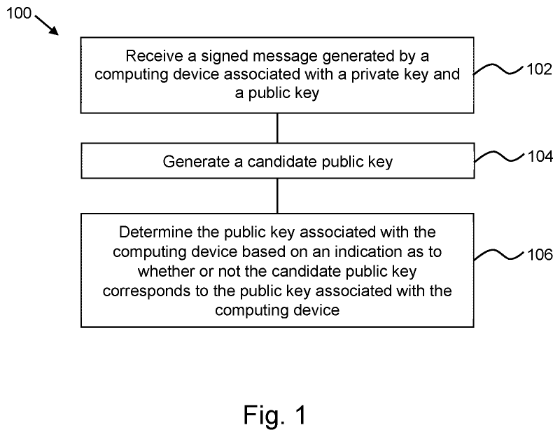

FIG. 1 depicts a flowchart of a method 100, which may be a computer-implemented method, of recovering a public key. In some examples, the method 100 may be implemented by a verifying entity (or ‘verifier’). In some examples, the method 100 may be implemented by a lookup service such as may be implemented by a CA. The method 100 may be used as part of a protocol to authenticate an identity of a computing device. The computing device may be an example of a ‘proving entity’, ‘prover’ or ‘signer’.

The method 100 comprises, at block 102, receiving a signed message generated by a computing device associated with a private key and a public key. The signed message comprises an input message signed with the private key.

The private key and public key may be a private/public key pair associated with the computing device. The private/public key pair may have been previously assigned to or generated by the computing device. The computing device may securely store or have access to its associated private key. The input message may comprise a sequence of characters, which may be received by, stored by or otherwise accessible to the computing device.

In some examples, the computing device may produce the signed message by implementing a digital signature algorithm (DSA) signing function. For example, in elliptic curve cryptography, the DSA signing function may be based on an elliptic curve DSA (ECDSA) signing function.

The DSA signing function may take, as its input, the input message and the private key of the computing device. An output of the DSA signing function may comprise a signature, which is an example of a ‘signed message’.

In some examples, certain parameters may be used as an input to the DSA signing function. Certain parameters used as the input may cause the DSA signing function to deterministically generate the output (i.e., the signature or signed message) that depends on these parameters. For example, an output of the ECDSA signing function may depend on a parameter that defines an elliptic curve (e.g., the parameter may be a coefficient or constant specified for an elliptic curve equation). In some examples, certain parameters used as the input to the DSA signing function may be randomly selected, pre-determined and/or otherwise selected.

Once generated, the signed message may be output by the computing device, and received as described in relation to block 102.

The method 100 further comprises, at block 104, generating a candidate public key based on the input message and the signed message using a public key recovery procedure. The candidate public key may be generated using processing circuitry (e.g., associated with the verifying entity and/or lookup service). Thus, in some examples, the verifying entity may generate the candidate public key. In some examples, the lookup service may generate the candidate public key.

In some examples, the public key recovery procedure may be based on a digital signature algorithm (DSA) verification function such as an ECDSA verification function.

In some examples, processing circuitry implementing a public key recovery protocol may take, as its input, the input message and the signed message. In some examples, at least one parameter used as an input to the DSA may also be input to the processing circuitry.

An output of the processing circuitry implementing the public key recovery protocol may comprise the candidate public key. In some examples, the output may comprise a plurality of (such as two or more than two) candidate public keys.

The method 100 further comprises, at block 106, determining the public key associated with the computing device based on an indication as to whether or not the candidate public key corresponds to the public key associated with the computing device. In some examples, the determining at block 106 may be implemented by processing circuitry, which may be the same or different to the processing circuitry referred to in relation to block 104.

The indication may enable a determination to be made as to whether or not the candidate public key corresponds to the public key associated with the computing device (i.e., the public key of the computing device's private/public key pair). As will be discussed in greater detail herein, the indication may be provided in various ways.

In some examples, the indication may indicate that the candidate public key corresponds to the public key associated with the computing device. In some examples, the indication may indicate that the candidate public key does not correspond to the public key associated with the computing device. In which case, another candidate public key generated according to the method 100 may be determined to be the public key associated with the computing device and/or an inference may be made as to an identity of the public key associated with the computing device.

By recovering the public key using certain methods described herein, a verifying entity may be able to verify the identity of the computing device based on a certificate binding the public key associated with the computing device to an identity attribute of the computing device. In some examples, the verifying entity may not need to know the computing device's identity when performing a verification (or ‘authentication’) procedure. As will be described in more detail herein, the recovery of the public key may facilitate and/or involve obtaining the certificate.

The recovery of the public key in accordance with certain methods described herein may facilitate the verifying entity access to the certificate without the computing device having to provide the certificate to the verifying entity. In other words, by recovering the public key, the verifying entity may be able to perform certain procedures such as authentication of the computing device, which may involve use of the certificate obtained in accordance with certain methods described herein.

In some examples, the verifying entity may be able to access the certificate in case the computing device itself does not possess or have access to its certificate (e.g., due to lack of storage or data loss). In some examples, the verifying entity may be able to access the certificate in case a communication medium between the computing device and the verifying entity does not have sufficient bandwidth to communicate the certificate so as to meet certain criteria (such as speed of transmission).

A computing device such as an embedded controller or smartcard may have a small amount of (expensive) non-volatile storage. By enabling the verifying entity to obtain the certificate for the computing device without the computing device itself sending its certificate (e.g., in accordance with certain methods described herein), the computing device may not need to store the certificate in its non-volatile storage, which may reduce the cost of the computing device and/or avoid concerns arising from the potential loss of the computing device's certificate.

In some examples, when interacting with an online service such as a cloud-based service, a computing device such as a user equipment (e.g., a mobile phone, personal computer, smart device) may not need to store its certificate in the computing device. Rather, the certificate could be managed by the online service and certain methods described herein may facilitate the interaction between the online service and the computing device.

In some examples, where a communication medium between the computing device and the verifying entity is constrained (e.g., due to bandwidth considerations), the verifying entity may still be able to obtain a certificate for the computing device without having to exchange a certificate over the communication medium. For example, a QR code-based pairing scheme for facilitating pairing of two devices (i.e., a computing device and a verifying entity) may allow one of the device to obtain the certificate associated with the other of the devices without having to directly exchange the certificate via a QR code (which may not be possible anyway due to bandwidth constraints). In another example, a Bluetooth or a Bluetooth Low Energy (BLE) beacon may have sufficient data capacity to fit a short signature rather than a long signature. When authenticating a computing device producing the Bluetooth or BLE beacon, certain methods described herein may avoid the need to transmit the certificate of the computing device over the beacon and instead may use the signature in order to obtain the certificate of the computing device.

In some examples, an entity such as an original equipment manufacturer (OEM) may wish to maintain control of the authentication of a computing device. For example, the entity may wish to prevent an unauthorized entity (e.g., in a subsequent stage of the manufacturing process) from authenticating a computing device since this may be a concern for sensitivity or privacy reasons. Certain methods described herein may ensure that an authorized entity can look up the identity of the computing device without the computing device's certificate being stored in the computing device itself, which may avoid the need to store the certificate on the device's potentially small amount of non-volatile memory. Any entity wishing to access the device's certificate may not be able to determine the identity of the computing device itself if the certificate is not stored in the computing device. Certain privacy concerns may be avoided if the certificate is not stored in the computing device.

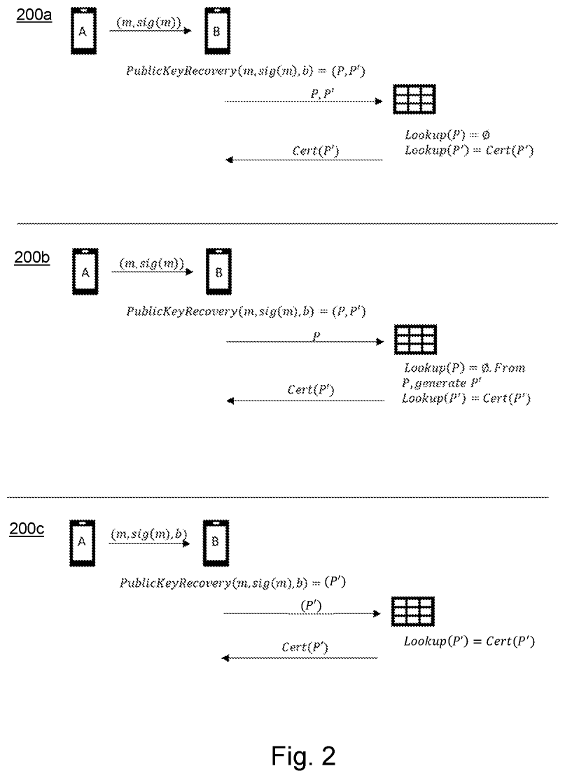

FIG. 2 shows various example systems 200a-c for recovering a public key. A certificate corresponding to the public key may be obtained using these systems 200a-c (e.g., as part of an authentication procedure to authenticate the computing device using the certificate after a verifying entity verifies its trust chain).

In systems 200a-c, a computing device (i.e., device ‘A’) signs an input message, m, with its private key to generate a signature, sig(m). The input message, m, and the signature, sig(m) is sent to a verifying entity (i.e., device ‘B’) as an initial handshake. As will be explained in more detail below, device B may retrieve the certificate associated with device A even if device A does not store its certificate or transmit its certificate to device B. Device B may then authenticate device A using the retrieved certificate after verifying its trust chain.

Thus, device B in the systems 200a-c may recover the public key and obtain the certificate associated with device A in such a way that the public key and/or the certificate of device A may not be stored and/or transmitted by device A.

In some examples, the input message to be signed depends on the protocol being used (e.g., which type of DSA signing function is being applied). In some examples, the input message, m, may be a challenge sent by device B to device A. In some examples, the input message, m, may be accessible to (e.g., stored by or generated by) device A.

In some examples, the input message, m, and the signature, sig(m), is sent to device B. In some examples, the signature, sign(m), is sent to device B without the input message, m, itself (e.g., if device B already knows the input message, m, which may be the case if, for example, the input message, m, is a challenge sent by device B).

However, in either case, device B implements a public key recovery procedure such as described in relation to certain methods described herein (e.g., method 100 or method 300) to recover the public key and/or the certificate associated with device A (i.e., without the public key and/or the certificate being transmitted from device A to device B). As part of this procedure, certain parameters (i.e., ‘b’ in system 200a) associated with the DSA (as used by the DSA signing function implemented by device A) may be used by the public key recovery procedure to generate the candidate public key. In the system 200a, two candidate public keys, P and P′, are generated by the public key recovery procedure.

In some examples, as part of a query, the two candidate public keys, P and P′, are provided to a lookup service for matching available certificates to corresponding public keys. In some examples, a digest or other indication of the two candidate public keys is provided to the lookup service, which may shorten the query.

The lookup service in system 200a checks to see whether either of the candidate public keys, P or P′, has a corresponding certificate. For example, the operation ‘Lookup(P)’ may yield no corresponding certificates (i.e., Lookup(P)=0) whereas the operation ‘Lookup(P′)’ may obtain the certificate, Cert(P′), for the candidate public key, P′, (i.e., Lookup(P′)=Cert(P′)). The lookup service may then provide the certificate, Cert(P′), to the device B. This certificate may be used to indicate to device B that the candidate public key, P′, is indeed the public key associated with device A. In some cases, both candidate public keys may have a corresponding certificate. However, in other cases, the lookup service may be able to indicate to device B, via the returned certificate, which is the correct public key associated with the device A.

Thus, device B may determine which of the candidate public keys, P or P′, is the correct public key associated with the device A based on the certificate it receives. The certificate may also be used as part of a verification procedure for verifying the identity of device A. In this example, the certificate received by device B corresponds to the indication referred to in block 106 of the method 100.

Similar to the system 200a, in system 200b, device A signs an input message, m, with its private key to generate a signature, sig(m). The signature, sig(m), (and in some examples the input message, m, as well as the signature, sig(m)) is sent to device B. Again, device B implements a public key recovery procedure such as described in relation to certain methods described herein (e.g., method 100 or method 300) to recover the public key and/or the certificate associated with device A (i.e., without the public key and/or the certificate being transmitted from device A to device B). As part of this procedure, certain parameters (i.e., ‘b’ in system 200b) associated with the DSA may be used by the public key recovery procedure to generate the candidate public key. In system 200b, two candidate public keys, P and P′, are generated by the public key recovery procedure.

In contrast to system 200a and in some examples, in system 200b, one of the two candidate public keys, P, is provided to the lookup service as part of a query. In some examples, a digest or other indication of the candidate public key, P, is provided to the lookup service, which may shorten the query.

If the operation ‘Lookup(P)’ returns a corresponding certificate (i.e., Lookup(P)=Cert(P)), this certificate may be provided to device B to indicate that the candidate public key, P, is indeed the correct public key associated with the device A. However, if the operation does not return a corresponding certification (i.e., Lookup(P)=0), the lookup service itself may determine the other candidate public key, P′. This other candidate public key, P′, is then used to query the lookup service and may return the corresponding certificate (i.e., Lookup(P′)=Cert(P′)). This certificate, Cert(P′) is then provided to device B to enable device B to determine which of the candidate public keys, P or P′, is the correct public key associated with the device A (as well as allowing the certificate to be used by device B for a verification procedure). Again, the certificate received by device B corresponds to the indication referred to in block 106 of the method 100.

Similar to the systems 200a and 200b, in system 200c, device A signs an input message, m, with its private key to generate a signature, sig(m). The signature, sig(m), (and in some examples the input message, m, as well as the signature, sig(m)) is sent to device B. Similar to systems 200a and 200b, in system 200c, the public key and/or the certificate associated with device A is not sent by device A to device B.

In contrast to the other systems 200a-b, in system 200c, device A also sends device B identifying information (e.g., metadata, a selection bit or other identifying information), b, to indicate which of the candidate public keys, P and P′, that are to be recovered by device B corresponds to the correct public key associated with the computing device. Additionally, as part of this procedure, certain parameters (i.e., ‘b’ in system 200c) associated with the DSA may be used by the public key recovery procedure to generate the candidate public key. Thus, when running the public key recovery procedure, device B can determine which candidate public key is the correct one based on this identifying information. The identifying information, b, received by device B from device A corresponds to the indication referred to in block 106 of the method 100. In some examples, the identifying information is smaller in data size than the public key or the certificate (for example, the identifying information may comprise a single selection bit), which may minimize the amount of data transmitted from device A to device B when device B recovers the public key and/or the certificate associated with device A. In some examples, the identifying information may be unauthenticated. However, the practical consequences of an attack comprising the identifying information may be regarded as minimal since another system (e.g., system 200a or 200b) could be implemented to recover the correct public key associated with device A.

In some examples, device B may then provide the recovered public key, P′, to the lookup service as part of a query. In some examples, a digest or other indication of the recovered public key, P′, may be provided to the lookup service, which may shorten the query.

The query may return and provide the corresponding certificate, Cert(P′), to the device B.

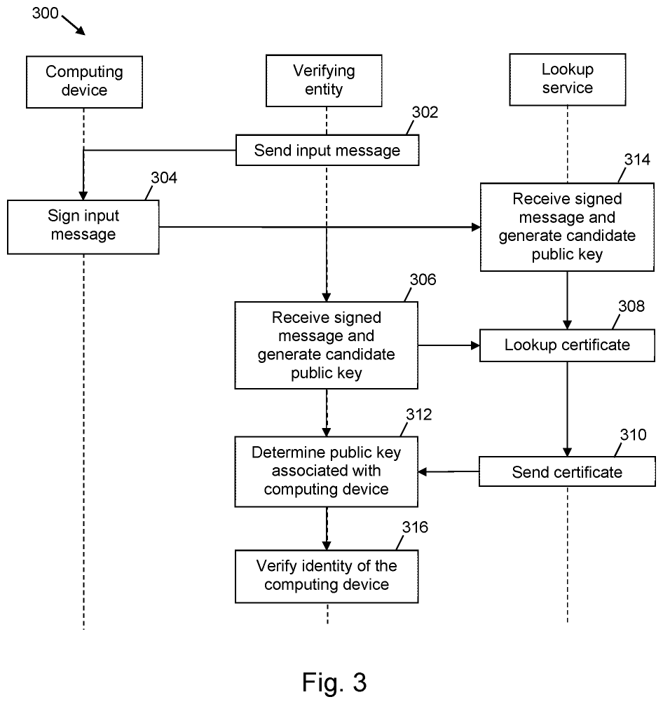

FIG. 3 depicts a flowchart of a method 300, which may be a computer-implemented method, of recovering a public key and/or determining a certificate associated with a computing device. The blocks in FIG. 3 are shown in relation to the entity (i.e., the computing device, the verifying entity or the lookup service) that performs the operation described in the block. As shown by FIG. 3, in some examples, the verifying entity may be a separate entity to the lookup service. However, in some examples, the verifying entity and the lookup service may be at least partially implemented by the same entity. For example, the information provided by the lookup service could be accessible in a local storage of the verifying entity.

Certain blocks of the method 300 may correspond to certain blocks of the method 100 depicted by FIG. 1. The method 300 may be implemented as part of or in addition to the method 100 of FIG. 1. In the description of the method 300 below, reference is also made to the systems depicted by FIG. 2.

In some examples, the input message may be a predetermined message that can be accessed (e.g., from a memory) or generated by the computing device. However, in some examples, the input message may be sent to the computing device (e.g., by the verifying entity) and the computing device may sign the input message with its private key. Thus, the method 300 may comprise, at block 302, causing the input message to be sent to the computing device. In some examples, the input message may cause the computing device to respond with the signed message.

The method 300 comprises, at block 304, generating the signed message by signing the input message with the private key of the computing device. The signed message is then sent to the verifying entity and/or the lookup service.

In some examples, the method 300 comprises, at block 306, receiving the signed message (which may correspond to block 102 of the method 100) and generating the candidate public key (which may correspond to block 104 of the method 100).

Based on the candidate public key generated at block 306, the method 300 comprises, at block 308, causing the lookup service to use the candidate public key to generate the indication based on whether or not the lookup service can identify a certificate corresponding to the public key associated with the computing device.

In some examples (such as depicted by system 200a of FIG. 2), generating the candidate public key (e.g., at block 306) comprises generating a first and second candidate public key based on the input message and the signed message. The method 300 may further comprise causing the lookup service to generate (e.g., at block 308) the indication using at least one of the first and second candidate public keys to determine which of the first and second candidate public keys corresponds to the public key associated with the computing device.

In some examples (such as depicted by system 200b of FIG. 2), generating the candidate public key (e.g., at block 306) comprises generating a first candidate public key based on the input message and the signed message. The method 300 may further comprise causing the lookup service to use (e.g., at block 308) the first candidate public key to determine whether or not the first candidate public key has an associated certificate. In this manner, where the first candidate public key has such an associated certificate, the lookup service may be caused to provide the indication, to thereby indicate that the first candidate public key corresponds to the public key associated with the computing device. However, where the first candidate public key does not have such an associated certificate, the lookup service may be caused to identify a second candidate public key based on the first candidate public key. The lookup service may further be caused to determine an associated certificate for the second candidate public key. The lookup service may further be caused to provide the indication, to thereby indicate that the second candidate public key corresponds to the public key associated with the computing device.

The lookup service may send, at block 310 of the method 300, the certificate corresponding to the correct public key associated with the computing device to the verifying entity. In some examples, the indication referred to in block 106 of the method 100 comprises the certificate corresponding to the public key associated with the computing device.

Based on the certificate provided by the lookup service at block 310, the verifying entity may determine, at block 312 of the method 300, the public key associated with the computing device (which may correspond to block 106 of the method 100).

Thus, in some examples, the method 300 comprises receiving, by the verifying entity, the signed message (e.g., based on block 306). The method 300 further comprises generating, by the verifying entity, the candidate public key (e.g., based on block 306). The method 300 further comprises causing the verifying entity to use a lookup service to determine whether or not the candidate public key has an associated certificate and thereby cause the lookup service to provide the indication (e.g., based on blocks 308 and 310).

In some examples the verifying entity may not perform the generating of the candidate public key (e.g., based on block 306). In this regard, the method 300 may comprise, at block 314, receiving, by a lookup service, the signed message (e.g., which may have been forwarded by the verifying entity). The method further comprises, at block 314, generating, by the lookup service, the candidate public key. The method 300 further comprises causing the lookup service to determine whether or not the candidate public key has an associated certificate and thereby cause the lookup service to provide at least one of: the indication (e.g., the certificate) and the public key associated with the computing device to the verifying entity (e.g., based on blocks 308 and 310).

Thus, in some examples, the lookup service may implement the public key recovery procedure. Using the signature to lookup the certificate may prevent bulk lookup attacks where the attacker submits guessable identifiers (e.g., serial numbers) to the lookup service. In other words, the signature may be regarded as a genuine confirmation that the request for the certificate was derived from a verifying entity with access to the computing device.

In some examples, the lookup service may restrict access to its lookup capabilities by requiring the verifying entity to first authenticate to the lookup service and/or by using a lookup rate restriction function.

In some examples and as part of a request to authenticate the computing device, the lookup service may generate the input message for the verifying entity to forward to the computing device. In this manner, the lookup service may know that the request is fresh and not a replayed message.

In some examples (e.g., as depicted by system 200c of FIG. 2), blocks 308 and 310 may not be implemented. In this regard, the indication may comprise identifying information received from the computing device to indicate which of a plurality of candidate public keys (e.g., generated by the processing circuitry of the verifying entity) corresponds to the public key associated with the computing device. In other words, the lookup service may not provide the indication. Rather, the computing device may provide the indication which, when the public key recovery procedure is implemented, causes the verifying entity to determine (e.g., at block 312) the candidate public key corresponding to the public key associated with the computing device (which may correspond to block 106 of the method 100).

Based on the public key associated with the computing device and the certificate provided by the lookup service, the verifying entity may verify, at block 316 of the method 300, an identity of the computing device. The verification may be performed by determining whether or not the public key determined to be associated with the computing device has an associated valid certificate issued by a certificate authority, which may be provided by the lookup service. The associated valid certificate may be obtained from the lookup service associated with the certificate authority. Thus, the verifying entity may trust the identity of the computing device providing the recovered public key corresponds to a valid certificate, which may be implied anyway by virtue of receiving the corresponding certificate from the lookup service.

In some examples, upon accessing or retrieving the certificate for the computing device, the verifying entity may validate its trust chain to the CA root and compare the recovered public key with the certificate. If the recovered public key corresponds to the certificate, the verifying entity may know the identity of the computing device. In some examples, the verifying entity may not need to validate the signature against the recovered public key since the public key recovery procedure may determine the correct public key, which is related to the private key of the private/public key pair associated with the computing device. In other words, the verifying entity may trust the identity of the computing device providing the recovered public key corresponds to a valid certificate.

A CA may issue a certificate for the computing device during an initial verification procedure. A CA may further maintain a service for reporting revoked certificates such as revocation lists or online protocols for querying a certificate's validity. CAs may also provide their root and intermediary certificates for validating trust chains. A CA may issue a replacement certificate upon request. This may involve the entity requesting the replacement certificate being able to prove something about their identity to potentially prevent massive data lookups. Providing general access to bulk certification information may otherwise enable access to private and/or sensitive data or enable denial of service attacks. In some examples, certain methods described herein may facilitate certificate revocation or replacement since the verifying entity may obtain the most up-to-date information regarding the computing device's certificate from the lookup service rather than from the computing device itself.

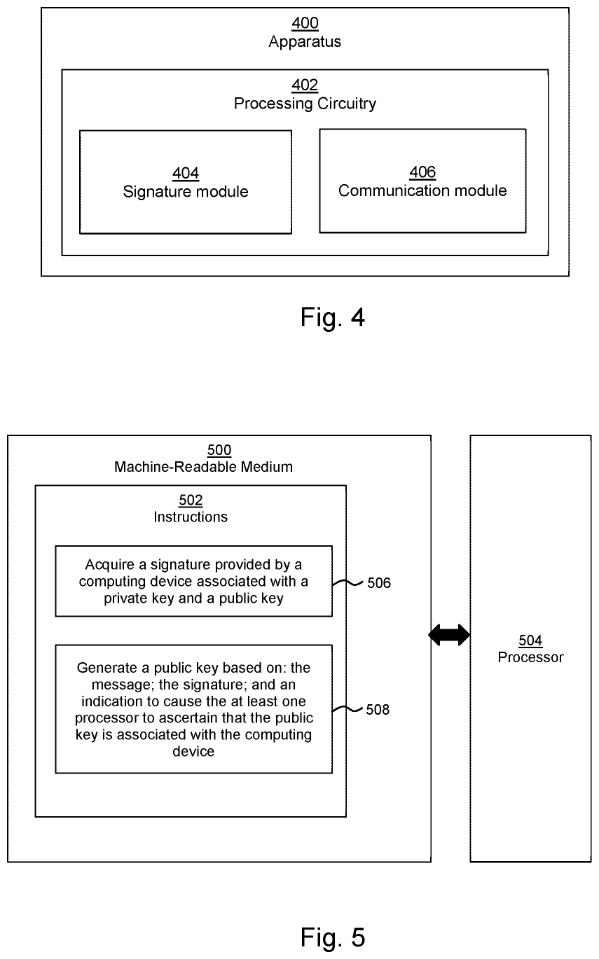

FIG. 4 shows an apparatus 400 (which in some examples may correspond to the computing device referred to in FIGS. 1 to 3 or device A in FIG. 2) comprising processing circuitry 402. The processing circuitry 402 may, for example, carry out blocks of the methods described herein and/or execute the instructions stored on a machine readable medium (e.g., comprising instructions for implementing certain methods described herein).

The processing circuitry 402 comprises a signature module 404. The signature module 404 is to generate a signature (e.g., a ‘signed message’) by signing a message (e.g., an ‘input message’) with a private key associated with the apparatus. For example, the signature may, in use, be generated as described in relation certain methods described herein.

The processing circuitry 402 further comprises a communication module 406. The communication module 406 is to receive an identification request from a verifier (e.g., a ‘verifying entity) attempting to identify a public key associated with the apparatus. In some examples, the verifier may be performing a verification procedure in order to verify the identity of the apparatus.

The communication module 406 is to send, in response to receiving the identification request, the signature to the verifier. The signature is to cause the verifier to generate a candidate public key in accordance with certain methods described herein. For example, the candidate public key may be generated by the verifier based on the message, the signature and an indicator (e.g., the ‘indication’ referring to in certain methods described herein) to cause the verifier to identify whether or not the candidate public key corresponds to the public key associated with the apparatus.

In some examples, the signature enables the verifier to identify the public key associated with the apparatus from the indicator without the apparatus providing the verifier with a certificate indicative of the public key associated with the apparatus.

In some examples, the communication module 406 is to send the indicator to the verifier, where the indicator is to cause the verifier to identify the candidate public key that corresponds to the public key associated with the apparatus. In other words, the indicator may correspond to the ‘identifying information’ referred to in certain methods described herein.

In some examples, the message to be signed by the signature module 404 is based on a one-way function that produces a different value for the message over time such that the signature depends on when the signature module 404 generates the signature, and such that the verifier generates the candidate public key based on knowledge of the one-way function.

Thus, in some examples, the verifier may know or be able to calculate the message that is to be signed by the apparatus 400. The message may be based on a deterministic and/or one-way function, which may facilitate a one-way authentication protocol. The one-way authentication protocol may streamline the process for obtaining a certificate and verifying the certificate in a single handshake with the apparatus 400. For example, the function may be based on a monotonically-increasing counter that produces a different value for the input message over time. The verifier may have knowledge of the function so can determine what the input message will be. In some examples, the apparatus 400 may comprise a printer which may sign the message to output the signature and send (e.g., by broadcasting) the signature to the verifier (i.e., the signature may be sent with or without the message, depending on whether or not the message can be accessed or determined by the verifier). A verifier such as a mobile phone could receive (e.g., detect) the signature and recover the public key as described in relation to certain methods described herein. The signature may be considered to be compact in terms of data size and may avoid the need to include an identifier for the apparatus 400 when authenticating the apparatus 400.

FIG. 5 schematically illustrates a machine-readable medium 500 (e.g., a tangible machine-readable medium) which stores instructions 502, which when executed by at least one processor 504, cause the at least one processor 504 to carry out certain example methods described herein (e.g., the method 100 of FIG. 1 or the method 300 of FIG. 3). In some examples, the machine-readable medium 500 may be implemented by a verifying entity and/or a lookup service such as referred to by certain methods or systems described herein.

The instructions 502 comprises instructions 506 to acquire a signature provided by a computing device associated with a private key and a public key. The signature comprises a message signed with the private key.

The instructions 502 comprises instructions 508 to generate (e.g., using a public key recovery protocol or procedure) a public key. The generation of the public key is based on: the message; the signature; and an indication to cause the at least one processor 504 to ascertain that the public key is associated with the computing device. The indication may correspond to the indication referred to by certain methods described herein.

In some examples, the instructions 502 are to cause the at least one processor 504 to verify an identity of the computing device based on a certificate acquired from a database indicative of a correspondence between the public key associated with the computing device and the certificate. The database may be provided by the lookup service referred to by certain methods described herein.

Examples in the present disclosure can be provided as methods, systems or as a combination of machine readable instructions and processing circuitry. Such machine readable instructions may be included on a non-transitory machine (for example, computer) readable storage medium (including but not limited to disc storage, CD-ROM, optical storage, etc.) having computer readable program codes therein or thereon.

The present disclosure is described with reference to flow charts and block diagrams of the method, devices and systems according to examples of the present disclosure. Although the flow charts described above show a specific order of execution, the order of execution may differ from that which is depicted. Blocks described in relation to one flow chart may be combined with those of another flow chart. It shall be understood that each block in the flow charts and/or block diagrams, as well as combinations of the blocks in the flow charts and/or block diagrams can be realized by machine readable instructions.

The machine readable instructions may, for example, be executed by a general purpose computer, a special purpose computer, an embedded processor or processors of other programmable data processing devices to realize the functions described in the description and diagrams. In particular, a processor or processing circuitry, or a module thereof, may execute the machine readable instructions. Thus functional modules of the apparatus 400 (for example, the signature module 404 and/or the communication module 408) and other devices or apparatus described herein may be implemented by a processor executing machine readable instructions stored in a memory, or a processor operating in accordance with instructions embedded in logic circuitry. The term ‘processor’ is to be interpreted broadly to include a CPU, processing unit, ASIC, logic unit, or programmable gate array etc. The methods and functional modules may all be performed by a single processor or divided amongst several processors.

Such machine readable instructions may also be stored in a computer readable storage that can guide the computer or other programmable data processing devices to operate in a specific mode.

Such machine readable instructions may also be loaded onto a computer or other programmable data processing devices, so that the computer or other programmable data processing devices perform a series of operations to produce computer-implemented processing, thus the instructions executed on the computer or other programmable devices realize functions specified by block(s) in the flow charts and/or in the block diagrams.

Further, the teachings herein may be implemented in the form of a computer program product, the computer program product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made without departing from the scope of the present disclosure. It is intended, therefore, that the method, apparatus and related aspects be limited by the scope of the following claims and their equivalents. It should be noted that the above-mentioned examples illustrate rather than limit what is described herein, and that many implementations may be designed without departing from the scope of the appended claims. Features described in relation to one example may be combined with features of another example.

The word “comprising” does not exclude the presence of elements other than those listed in a claim, “a” or “an” does not exclude a plurality, and a single processor or other unit may fulfill the functions of several units recited in the claims.

The features of any dependent claim may be combined with the features of any of the independent claims or other dependent claims.

1. A method, comprising:
receiving a signed message generated by a computing device associated with a private key and a public key, where the signed message comprises an input message signed with the private key;
generating, using processing circuitry, a candidate public key based on the input message and the signed message using a public key recovery procedure; and
determining the public key associated with the computing device based on an indication as to whether or not the candidate public key corresponds to the public key associated with the computing device.

2. The method of claim 1, comprising causing a lookup service to use the candidate public key to generate the indication based on whether or not the lookup service can identify a certificate corresponding to the public key associated with the computing device.

3. The method of claim 2, where the indication comprises the certificate corresponding to the public key associated with the computing device.

4. The method of claim 2, where generating the candidate public key comprises generating a first and second candidate public key based on the input message and the signed message, and the method further comprises causing the lookup service to generate the indication using at least one of the first and second candidate public keys to determine which of the first and second candidate public keys corresponds to the public key associated with the computing device.

5. The method of claim 2, where generating the candidate public key comprises generating a first candidate public key based on the input message and the signed message, and the method further comprises causing the lookup service to use the first candidate public key to determine whether or not the first candidate public key has an associated certificate such that:
where the first candidate public key has such an associated certificate, the lookup service is caused to provide the indication, to thereby indicate that the first candidate public key corresponds to the public key associated with the computing device, and
where the first candidate public key does not have such an associated certificate, the lookup service is caused to: identify a second candidate public key based on the first candidate public key; determine an associated certificate for the second candidate public key; and provide the indication, to thereby indicate that the second candidate public key corresponds to the public key associated with the computing device.

6. The method of claim 1, where the indication comprises identifying information received from the computing device to indicate which of a plurality of candidate public keys generated by the processing circuitry corresponds to the public key associated with the computing device.

7. The method of claim 1, comprising causing the input message to be sent to the computing device, where the input message is to cause the computing device to respond with the signed message.

8. The method of claim 1, where:
receiving the signed message comprises receiving, by a verifying entity, the signed message; and
generating the candidate public key comprises generating, by the verifying entity, the candidate public key, the method further comprising:
causing the verifying entity to use a lookup service to determine whether or not the candidate public key has an associated certificate and thereby cause the lookup service to provide the indication.

9. The method of claim 1, where:
receiving the signed message comprises receiving, by a lookup service, the signed message; and
generating the candidate public key comprises generating, by the lookup service, the candidate public key, the method further comprising:
causing the lookup service to determine whether or not the candidate public key has an associated certificate and thereby cause the lookup service to provide at least one of: the indication and the public key associated with the computing device to a verifying entity.

10. The method of claim 1, further comprising verifying an identity of the computing device by determining whether or not the public key determined to be associated with the computing device has an associated valid certificate issued by a certificate authority, where the associated valid certificate is obtained from a lookup service associated with the certificate authority.

11. A tangible machine-readable medium storing instructions which, when executed by at least one processor, cause the at least one processor to:
acquire a signature provided by a computing device associated with a private key and a public key, where the signature comprises a message signed with the private key; and
generate, using a public key recovery protocol, a public key based on: the message; the signature; and an indication to cause the at least one processor to ascertain that the public key is associated with the computing device.

12. The tangible machine-readable medium of claim 11, where the instructions are to cause the at least one processor to:
verify an identity of the computing device based on a certificate acquired from a database indicative of a correspondence between the public key associated with the computing device and the certificate.

13. Apparatus comprising processing circuitry, the processing circuitry comprising:
a signature module to generate a signature by signing a message with a private key associated with the apparatus; and
a communication module to:
receive an identification request from a verifier attempting to identify a public key associated with the apparatus; and
send, in response to receiving the identification request, the signature to the verifier to cause the verifier to generate a candidate public key based on the message, the signature and an indicator to cause the verifier to identify whether or not the candidate public key corresponds to the public key associated with the apparatus.

14. The apparatus of claim 13, where the signature is to enable the verifier to identify the public key associated with the apparatus from the indicator without the apparatus providing the verifier with a certificate indicative of the public key associated with the apparatus.

15. The apparatus of claim 13, where the communication module is to send the indicator to the verifier, where the indicator is to cause the verifier to identify the candidate public key that corresponds to the public key associated with the apparatus.
